(19) United States
(12) Patent Application Publication
(10) Pub. No.: US 2010/0193113 A1
(43) Pub. Date: Aug. 5, 2010

(54) SHEET FINISHING APPARATUS, SHEET FINISHING METHOD AND IMAGE FORMING APPARATUS

(75) Inventor: Yasunobu TERAO, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/694,735

(22) Filed: Jan. 27, 2010

Related U.S. Application Data
(60) Provisional application No. 61/150,251, filed on Feb. 5, 2009.

(51) Int. Cl. B31F 1/00; B65C 9/46

(52) U.S. Cl. 156/200; 156/387

(57) ABSTRACT

A sheet finishing apparatus includes a cutter unit which is disposed on a conveyance path of a sheet, and forms a cut for tag formation in the sheet from a starting point close to a center line of the sheet orthogonal to a conveyance direction, a folding unit which is disposed downstream of the cutter unit on the conveyance path, bends the sheet around the center line, and raises an area defined by the cut in the sheet by the bending to form the tag.

### CROSS-REFERENCE TO RELATED APPLICATION

This application is based upon and claims the priority of U.S. Provisional Application No. 61/150,251, filed on Feb. 5, 2009, the entire contents of which are incorporated herein by reference.

### TECHNICAL FIELD

The present invention relates to a sheet finishing apparatus to perform finishing on a sheet discharged from an image forming apparatus such as a copying machine, a printer or a multifunction peripheral (MFP), a sheet finishing method and an image forming apparatus, and particularly to a finisher to fold a sheet in two and to discharge it.

### BACKGROUND

In recent years, in an image forming apparatus (for example, an MFP), a sheet finishing apparatus is provided adjacently to a latter stage of the MFP in order to perform finishing on a sheet after image formation. The sheet finishing apparatus is called a finisher, and staples the sheet sent from the MFP or sorts, and discharges the sheet to a storage tray from a discharge port. Besides, there is also a finisher including a saddle folding unit to form a bundle of plural sheets supplied from the image forming apparatus and to fold the sheet in two.

When a sheet bundle is folded in two, in order to prevent printed information from being easily seen by a third person, the sheet bundle is bent so that the print surface becomes the inside, and the sheet bundle is discharged. However, when the sheet bundle is folded so that the print surface becomes the inside, since only the back side of the sheet is seen, impossible to distinguish who printed the sheet discharged to the storage tray. Accordingly, necessary to realize that possible to distinguish who printed the sheet folded in two and discharged.

JP-A-9-175725 discloses a tab sheet forming apparatus. JP-A-9-175725 discloses an example in which a cut is made in a portion close to the edge of a sheet, the cut portion is bent to form a tab sheet, and a name of a printing person or the like is printed on the tab sheet. However, in order to bend the cut portion, necessary to provide a dedicated bending section.

Besides, JP-R-2005-125566 discloses an image forming apparatus including a U-shaped cutter which makes a cut at a position close to an edge of a sheet. In JP-A-2005-125566, a folded area defined by the cut is bent to form an index. However, necessary to provide a dedicated bending unit in order to bend the folded area, and there is a problem that the inner structure becomes complicated.

### SUMMARY

An embodiment of the present invention is to provide a sheet finishing apparatus which can form a tag for an index by a simple mechanism.

According to an aspect of the present invention, a sheet finishing apparatus including:

a cutter unit which is disposed on a conveyance path of a sheet, and forms a cut for tag formation in the sheet from a starting point close to a center line of the sheet orthogonal to a conveyance direction;

a folding unit which is disposed downstream of the cutter unit on the conveyance path, bends the sheet around the center line, and raises an area defined by the cut by the bending to form the tag; and
a storage tray to which the sheet bent by the folding unit is discharged.

### DESCRIPTION OF THE DRAWING

FIG. 1 is a structural view showing an embodiment of an image forming apparatus including a sheet finishing apparatus.

FIG. 2 is a structural view showing the details of a finisher.

FIG. 3 is a perspective view of the finisher seen from the side of a storage tray.

FIG. 4A to FIG. 4C are operation explanatory views of a saddle folding unit.

FIG. 5 is perspective view showing a state in which a sheet bundle folded in two is discharged.

FIG. 6 is a side view schematically showing the sheet bundle discharged to a storage tray.

FIG. 7A to FIG. 7D are operation explanatory views showing a forming process of a tag.

FIG. 8 is a perspective view showing an example of a cutter unit.

FIG. 9 is a plan view of the cutter unit of FIG. 8.

FIG. 10 is an operation explanatory view showing the movement of a cutter with respect to a sheet.

FIG. 11A to FIG. 11C are explanatory views showing positions of cuts formed by the cutter unit.

FIG. 12 is a perspective view showing another example of a cutter unit.

FIG. 13A and FIG. 13B are explanatory views showing a cut formed by the cutter unit of FIG. 12 and a tag.

FIG. 14A to FIG. 14C are explanatory views showing shapes of cuts formed by the cutter unit of FIG. 12.

FIG. 15 is an explanatory view showing a display example of an identification image when a tag is formed.

FIG. 16A to FIG. 16C are explanatory views showing examples in which directions of cuts are changed.

FIG. 17 is a block diagram showing a control system of the image forming apparatus and the sheet finishing apparatus.

### DETAILED DESCRIPTION

Throughout this description, the embodiments and examples shown should be considered as exemplars, rather than limitations on the apparatus of the present invention.

Hereinafter, an embodiment of a sheet finishing apparatus will be described in detail with reference to the drawings. Incidentally, the same portion in the respective drawings is denoted by the same reference numeral.

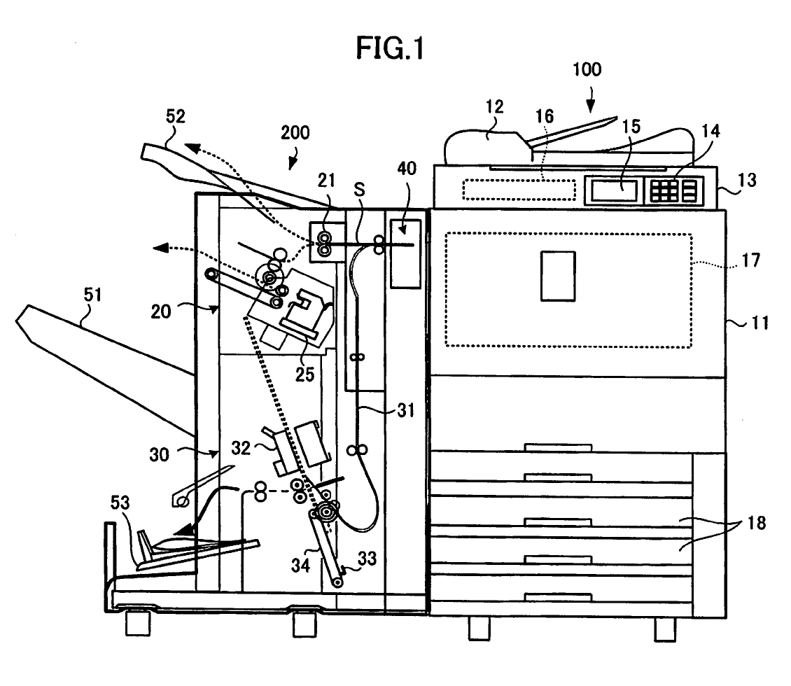

FIG. 1 is a structural view showing an image forming apparatus including a sheet finishing apparatus.

In FIG. 1, an image forming apparatus 100 is, for example, an MFP (Multi-Function Peripherals) as a composite machine, a printer, a copying machine or the like. A sheet finishing apparatus 200 is disposed adjacently to the image forming apparatus 100. A sheet on which an image is formed by the image forming apparatus 100 is conveyed to the sheet finishing apparatus 200.

The sheet finishing apparatus 200 performs finishing on the sheet supplied from the image forming apparatus 100, and performs, for example, sorting and stapling. Besides, as the need arises, the sheet is folded in two and is discharged. The sheet finishing apparatus 200 is hereinafter called a finisher 200.

A document table is disposed at an upper part of a main body 11 of the image forming apparatus 100, and an auto document feeder (ADF) 12 is openably and closably provided on the document table. The operation panel 13 is provided at an upper part of the main body 11. The operation panel 13 includes an operation section 14 including various keys and a touch panel type display section 15.

The main body 11 contains a scanner section 16 and a printer section 17, and plural cassettes 18 containing various sizes of sheets are provided at a lower part of the main body 11. The scanner section 16 reads a document sent by the ADF 12 or a document placed on the document table.

The printer section 17 includes a photoconductive drum, a laser and the like, scans and exposes the surface of the photoconductive drum with a laser beam from the laser, and forms an electrostatic latent image on the photoconductive drum. A charging unit, a developing unit, a transfer unit and the like are disposed around the photoconductive drum. The electrostatic latent image on the photoconductive drum is developed by the developing unit, and a toner image is formed on the photoconductive drum. The toner image is transferred to a sheet by the transfer unit. The structure of the printer 17 is not limited to the foregoing example, but various types are adopted. Besides, the image forming apparatus 100 has a function to print on both sides of a sheet, and after printing is performed on one surface of a sheet, the sheet is reversed, and printing can be performed on the other surface.

The sheet on which an image is formed in the main body 11 is conveyed to the finisher 200. In the example of FIG. 1, the finisher 200 includes a staple unit 20 to staple a sheet bundle, a saddle folding unit 30 to fold a sheet in two, and a cutter unit 40 to form a cut in a sheet in order to form a tag for an index. The sheet stapled or sorted by the staple unit 20 is discharged to a storage tray 51 or a fixed tray 52. Besides, the sheet folded in two by the saddle folding unit 30 is discharged to a storage tray 53.

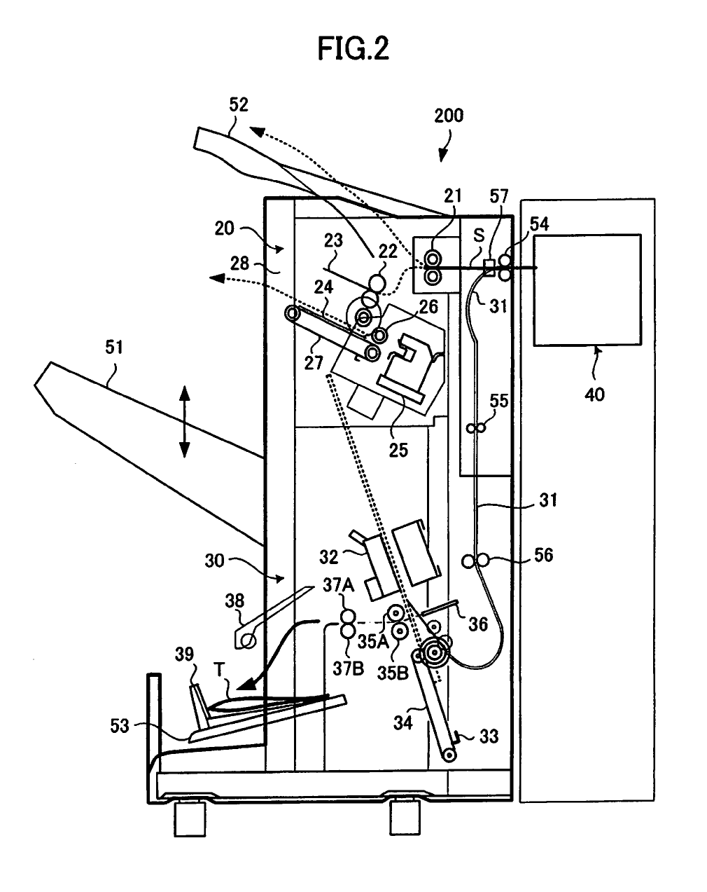

The structure of the finisher 200 will be described also with reference to FIG. 2. FIG. 2 is an enlarged view showing the staple unit 20 and the saddle folding unit 30. A sheet S supplied to the staple unit 20 through the cutter unit 40 is received by an inlet roller 21 of the staple unit 20 through a conveyance roller 54. A paper feed roller 22 is disposed downstream of the inlet roller 21, and sends the sheet S received by the inlet roller 21 to a standby tray 23. Each of the inlet roller 21 and the paper feed roller 22 includes an upper roller and a lower roller, and is driven by a motor.

A processing tray 24 on which the sheet S dropped from the standby tray 23 is stacked is disposed below the standby tray 23. The standby tray 23 stacks the sheet S and has an openable structure. When a specified number of sheets S are stacked, the standby tray 23 is opened, and the sheets S drop onto the processing tray 24 by their own weight or an operation of a drop assistant member. While the sheets S are stapled by the stapler 25, the processing tray 24 aligns the sheets S and stacks them.

The sheets S stacked on the processing tray 24 are guided to the stapler 25 by a vertical alignment roller 26 and are stapled. Besides, a conveyance belt 27 to convey the stapled sheets S to the storage tray 51 is provided. The sheets S conveyed by the conveyance belt are discharged to the storage tray 51 through a discharge port 28. The storage tray 51 moves up and down, and receives the sheets S. The sheet S may be discharged to the storage tray 51 without being stapled. When the sheets S are not stapled, the sheets S are not dropped to the processing tray 24 but are discharged.

The staple unit 20 includes an alignment device to align the conveyed sheet in the width direction, and uses the alignment device to sort the sheet and can discharge the sheet. Incidentally, when the finishing is not performed, the sheet conveyed from the main body 11 is directly discharged to the storage tray 51 or the fixed tray 52.

Next, the structure of the saddle folding unit 30 will be described. The saddle folding unit 30 forms a bundle of plural sheets supplied from the image forming apparatus 10 and folds it in two.

The sheet S conveyed from the image forming apparatus 100 is conveyed through a paper path 31, is conveyed in a direction toward the stapler 32, and is once received by a stack tray 33. The sheets S conveyed in sequence are stacked on the stack tray 33 and form a sheet bundle T.

The sheet bundle T on the stack tray 33 is conveyed in the direction toward the stapler 32 by a guide belt 34. When the center of the sheet bundle T reaches the stapler 32, the guide 34 belt once stops, and the center of the sheet bundle T is stapled.

The sheet bundle T stapled by the stapler 32 moves down by the guide belt 34, and is stopped at a position where the center of the sheet bundle T reaches a nip point between a folding roller pair 35A, 35B. A blade 36 is disposed at a position opposite to the folding roller pair 35A, 35B.

The blade 36 projects the center of the sheet bundle T to the nip point between the folding roller pair 35A, 35B, and pushes the sheet bundle T between the folding rollers 35A and 35B. The folding roller pair 35A, 35B rotate while folding and nipping the sheet bundle T, and folds the sheet bundle T in two. The sheet bundle T folded in two is conveyed by a discharge roller pair 37A, 37B, and is discharged to the storage tray 53. A drive motor is provided to rotate and drive the folding roller pair 35A, 35B and the discharge roller pair 37A, 37B.

Incidentally, guide rollers 55 and 56 are provided to guide the sheet S supplied from the image forming apparatus 100 along the paper path 31. Besides, a gate 57 is provided at the outlet of the conveyance roller 54 in order to switch the conveyance path of the sheet S1 supplied from the image forming apparatus 100 between the staple unit 20 side and the saddle folding unit 30 side.

When the sheet is not folded, the gate 57 conveys the sheet S discharged from the image forming apparatus 100 to the inlet roller 21 of the staple unit 20. When the sheet is folded, the sheet S is conveyed to the saddle folding unit 30.

On the other hand, the cutter unit 40 is positioned between, for example, the main body 11 and the staple unit 20. Incidentally, the position of the cutter unit 40 is not limited to the illustrated position, but may be any position as long as the position is located upstream of the saddle folding unit 30.

The cutter unit 40 makes a cut in the sheet S at the center in the conveyance direction. Since the cut is formed by the cutter unit 40, when the sheet S is folded in two by the saddle folding unit 30, an area defined by the cut is raised, and a tag for an index is formed. The details of the formation of the cut and the tag will be described later.

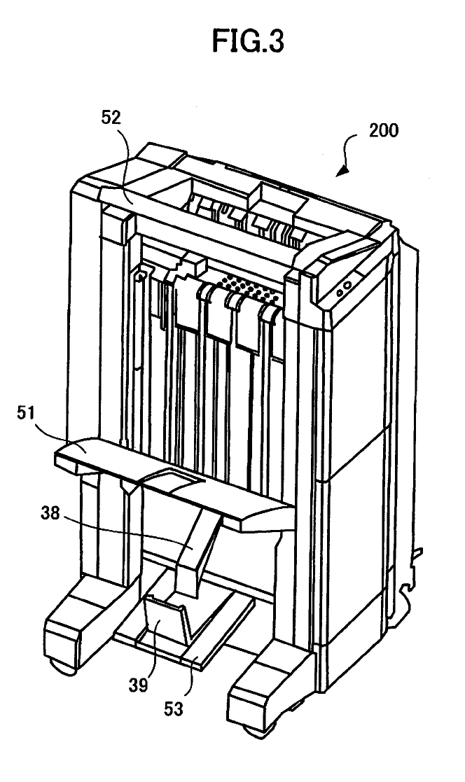

FIG. 3 is a perspective view of the finisher 200 when seen from the side of the storage trays 51 and 53. The storage tray 51 can move up and down, and receives the sheet S discharged from the staple unit 20. Besides, the storage tray 53 receives the sheet S or the sheet bundle T folded in two by the saddle folding unit 30. A press mechanism 38 to press the sheet S or the sheet bundle T folded in two and a stopper 39 to receive the discharged sheet S or the sheet bundle T are provided in the vicinity of the storage tray 53.

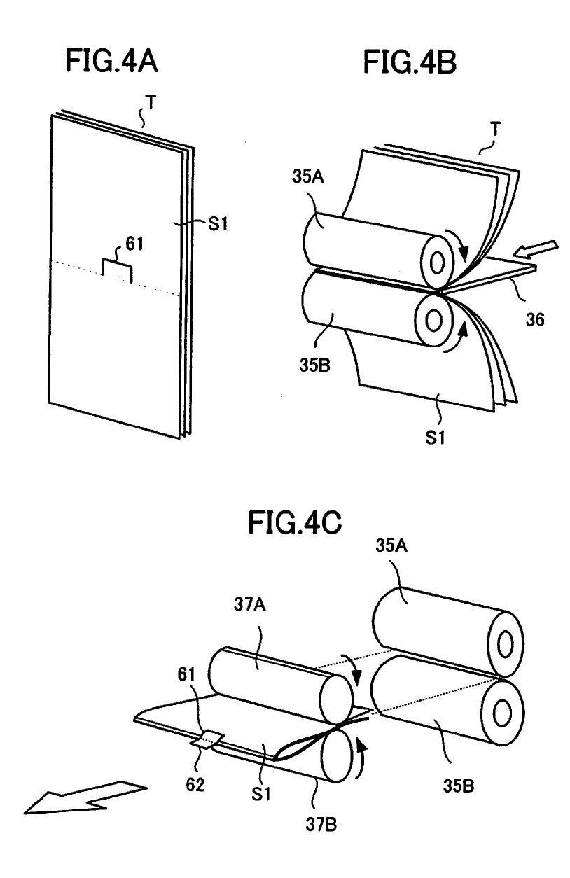

FIG. 4A to FIG. 4C are operation explanatory views of the saddle folding unit 30. The cutter unit 40 makes a cut 61 in the sheet S1 conveyed from the image forming apparatus 100. The cut 61 is formed in a U-shape from the starting point near the center line of the sheet S1 orthogonal to the conveyance direction. Incidentally, since the cut 61 is for forming the tag for the index, when not necessary to form the tag, the sheet S1 passes through the cutter unit 40 without formation of the cut 61.

The sheet S1 is conveyed through the paper path 31, and is received by the stack tray 33 before being sent to the stapler 32. FIG. 4A shows the sheet bundle T sequentially conveyed and stacked on the stack tray 33. When the sheet bundle T is folded in two, the cut 61 is formed only in one sheet S1 which becomes the outermost sheet when folded. Besides, when one sheet S1 is folded in two, the cut 61 is formed only in the one sheet. Hereinafter, the description will be made on the assumption that the cut 61 is formed in the outermost sheet S1 (sheet which becomes the cover sheet) of the sheet bundle T.

Next, the sheet bundle T is conveyed to the stapler 32 by the guide belt 34, and when the center of the sheet bundle T reaches the stapler 32, the stapler 32 staples the center of the sheet bundle T. The cut 61 is formed at a position avoiding the position of the staple. Incidentally, when not necessary to staple, stapling of the stapler 32 is omitted.

The stapled sheet bundle T moves down by the guide belt 34. When the center of the sheet bundle T reaches the nip point between the folding roller pair 35A, 35B, as shown in FIG. 4B, the blade 36 projects the center of the sheet bundle T to the nip point between the folding roller pair 35A, 35B, and pushes the sheet bundle T between the folding rollers 35A and 35B. The roller pair 35A, 35B rotate to wind the sheet bundle T, and the sheet bundle T is folded and is discharged.

As shown in FIG. 4C, the fold strength of the sheet bundle T folded in two is reinforced by the discharge roller pair 37A, 37B, and is discharged to the storage tray 53. The sheet S1 discharged to the storage tray 53 is folded by the folding rollers 35A and 35B. However, the area defined by the cut 61 is raised by the rigidity of the sheet S1, and rises also after the discharge roller pair 37A, 37B pass, and the tag 62 for the index is formed.

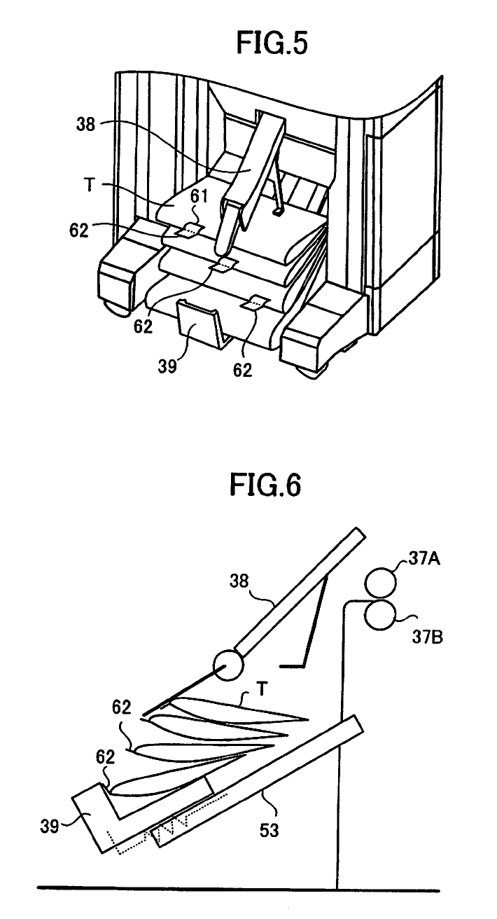

FIG. 5 is a perspective view showing a state where the sheet bundle T folded in two is discharged on the storage tray 53. FIG. 6 is a side view schematically showing the sheet bundle T discharged on the storage tray 53. FIG. 5 and FIG. 6 show the state where plural (for example, four) sheet bundles T are folded in two and are discharged. The tag 62 is formed on each of the sheet bundles T. Besides, the position of the tag 62 is shifted, and the position of the tag 62 is changed for each user. When the cut 61 is formed at a different position along the center line (fold portion) of the sheet S1, the position of the tag 62 can be changed.

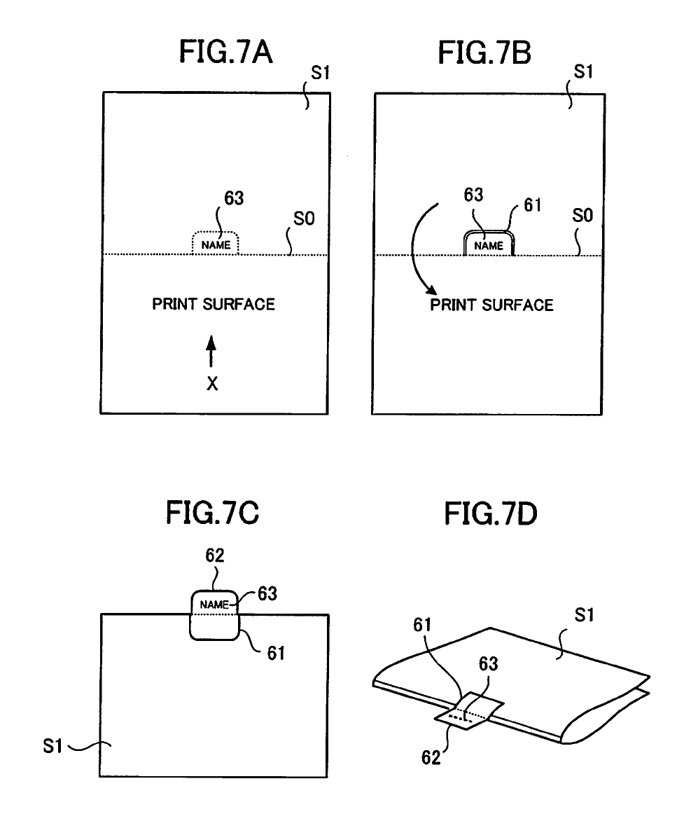

FIG. 7A to FIG. 7D are operation explanatory views showing a forming process of the tag 62. FIG. 7A shows a print surface side of the sheet S1 conveyed to the finisher 200 from the image forming apparatus 100. The center line along which the sheet S1 is folded in two and which is orthogonal to the conveyance direction is represented by a center line S0. The cut 61 is formed from the starting point near the center line S0. FIG. 7A shows a case where the cut 61 is formed in the middle portion of the center line S0. When the sheet S1 is conveyed in an X direction, the cut 61 is formed in a direction toward the front end of the sheet S1.

An identification image 63 (NAME) to identify the user is printed in the area defined by the cut 61. The position where the identification image 63 is printed is determined by the image forming apparatus 100, and the user name or the like is printed at the position previously set according to the sheet size or each user. The identification image 63 has only to enable identification of a printing person, and a user name (printing person name), a belonging department name, a symbol, a numeral, a specific color or the like may be adopted.

FIG. 7B shows the sheet S1 in which the cut 61 is formed by the cutter unit 40. The sheet S1 in which the cut 61 is formed is folded by the folding rollers 35A and 35B with respect to the position of the center line S0. When the sheet S1 is folded, as shown in FIG. 7C, since the portion of the cut 61 is raised by the rigidity of the sheet S1, the tag 62 is formed. When the rising of the tag 62 is insufficient, the user can raise the tag 62 by the fingers. Since the cut 61 exists, tag 62 is easy to raise.

FIG. 7D is a perspective view showing the sheet S1 folded in two, and shows a state where the tag 62 is formed. In this embodiment, the sheet bundle T is folded by the saddle folding unit 30, so that the tag 62 can be raised. That is, when the sheet S1 is folded, since it can not be completely folded, the back portion rises. Accordingly, attention is paid to the rising, and when the cut 61 is made in the center of the sheet S1, the tag 62 can be formed.

Since the identification image 63 is printed on the inside (surface which can be seen from above in FIG. 7D) of the tag 62, when the identification image 63 is confirmed, possible to easily know who printed. Besides, since the inside of the folded sheet S1 becomes the print surface, printed information is concealed, and useful also for security protection.

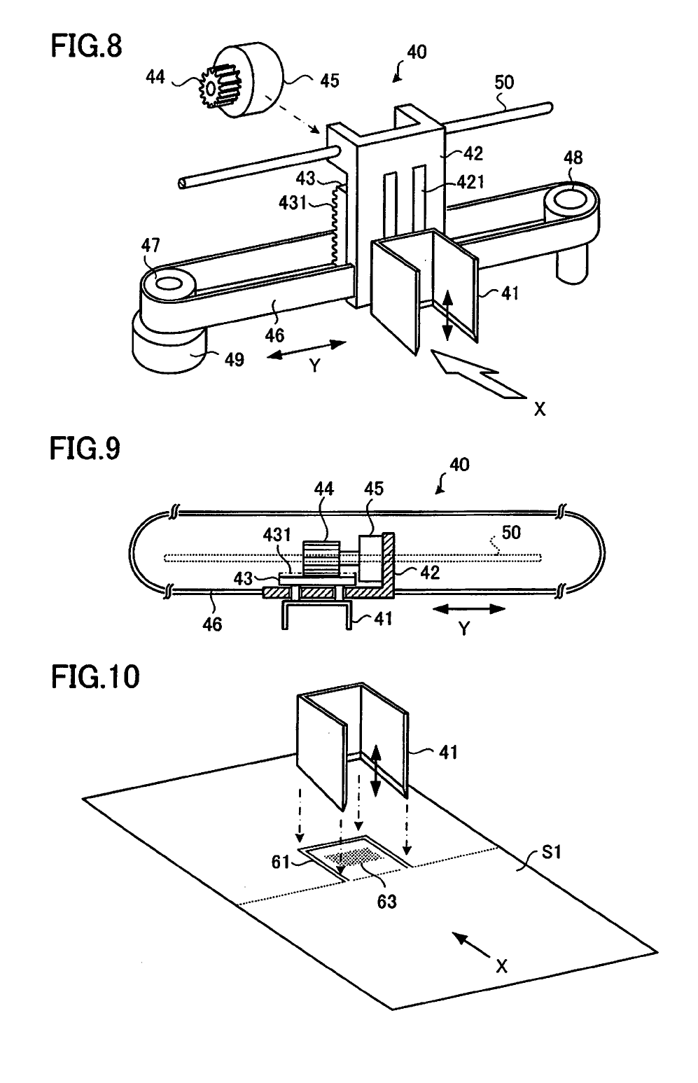

FIG. 8 is a perspective view showing a main part of the cutter unit 40, and FIG. 9 is a plan view of the cutter unit 40. The cutter unit 40 includes a U-shaped cutter 41, a support member 42 to support the cutter 41 slidably in the up-and-down direction, and an elevator member 43 to move the cutter 41 up and down.

The support member 42 is provided with a guide slit 421 extending in the up-and-down direction, and the cutter 41 and the elevator member 43 are integrally formed through the guide slit 421. The elevator member 43 is provided with a rack 431, a gear 44 is attached to engage with the rack 431, and a motor 45 rotates the gear 44. The motor 45 is attached to the support member 42.

A circular belt 46 is fixed to the support member 42. The circular belt 46 is stretched between a pulley 47 and a pulley 48, and the pulley 47 is rotated by a motor 49. When the motor 49 rotates, the circular belt 46 is rotated, and the support member 41 moves along a rail 50 in the Y direction orthogonal to the conveyance direction X of the sheet S1. Besides, when the motor 45 rotates, the gear 44 is engaged with the rack 431 of the elevator member 43 for rotation, and the elevator member 43 moves up and down. The cutter 41 also moves up and down by the moving up and down of the elevator member 43.

FIG. 10 is an operation explanatory view showing the movement of the cutter 41 with respect to the sheet S1. The sheet S1 is conveyed below the cutter 41 in the arrow X direction. In the example of FIG. 10, the cutter 41 is disposed to face the print surface of the sheet S1. When the center of the sheet S1 is conveyed to a position to face the tip of the cutter 41, the conveyance of the sheet S1 is once stopped, and the cutter 41 moves down to the sheet surface direction, and forms the cut 61. After the cut 61 is formed, the cutter 41 is raised and the sheet S1 is conveyed. In order to prevent the sheet S1 from being torn when a cut is made in the sheet S1, the tip of the cutter 41 opposite to the sheet S1 is slightly inclined.

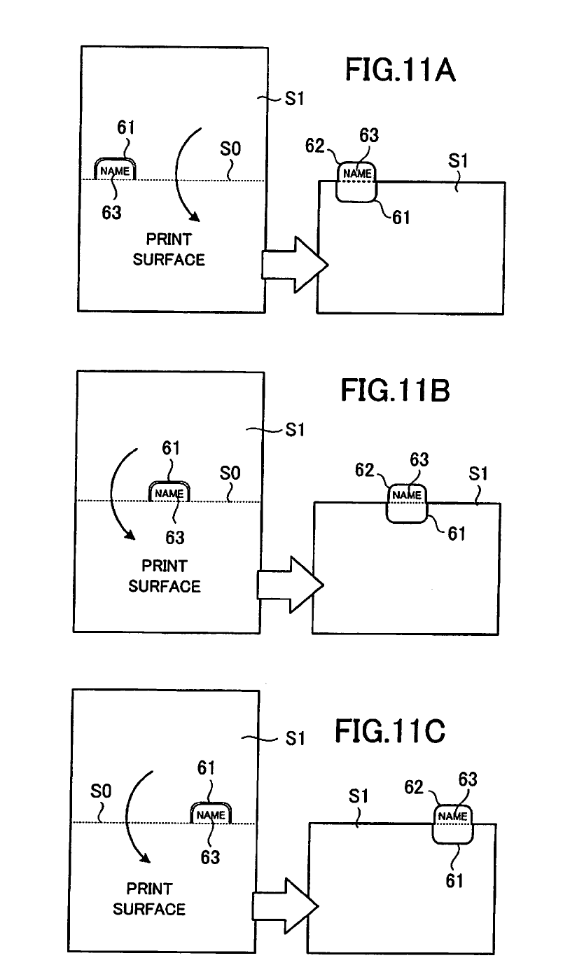

FIG. 11A to FIG. 11C show positions of cuts 61 formed by the cutter unit 40. FIG. 11A to FIG. 11C are views in which the sheet S1 is seen from the print surface. FIG. 11A shows an example in which the position of the cut 61 is set on the left side of the center line S0 of the sheet S1, FIG. 11B shows an example in which the position of the cut 61 is set at the center of the center line S0, and FIG. 11C shows an example in which the position of the cut 61 is set on the right side of the center line S0. The position of the cut 61 can be changed by rotating the motor 49 and by moving the cutter 41. The position of the cut 61 is changed for each user, so that the position of the tag 62 is changed. Accordingly, on the basis of the position of the tag 62, possible to know who printed.

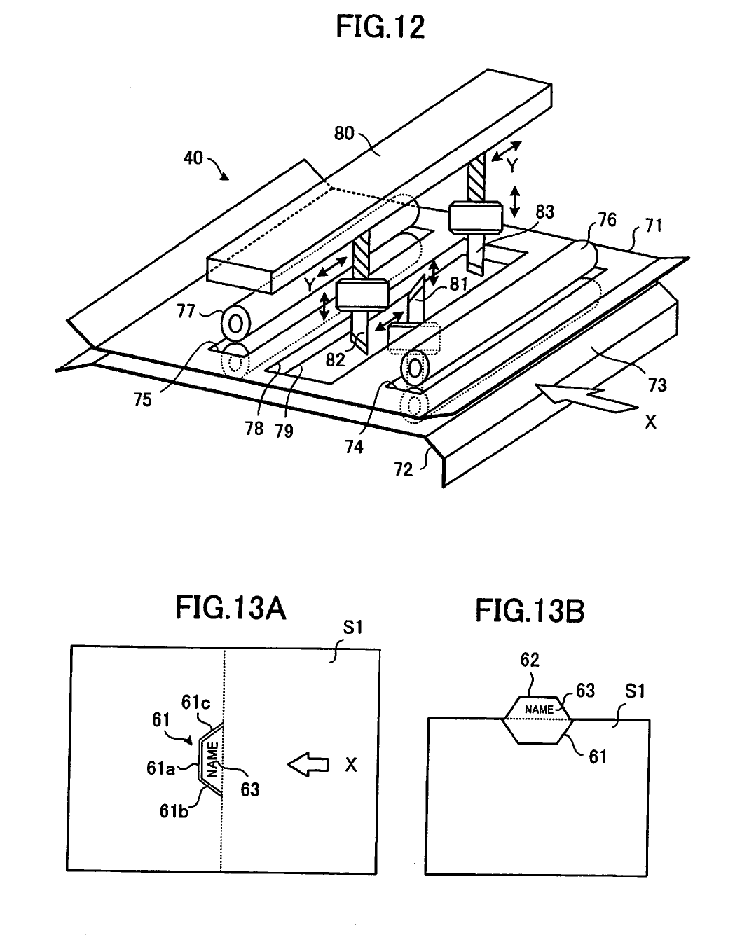

FIG. 12 is a perspective view showing another embodiment of a cutter unit 40. In the example of FIG. 12, two guides 71 and 72 forming a conveyance path of a sheet S1 are disposed in the up-and-down direction, and a paper feed port 73 is provided. Openings 74 and 75 are respectively formed in the guides 71 and 72 on a paper feed side and a paper discharge side, and conveyance rollers 76 and 77 are provided in the openings 74 and 75. The conveyance rollers 76 and 77 are driven by motors.

Besides, openings 78 and 79 are formed in the guides 71 and 72 between the conveyance rollers 76 and 77. A cutter 81 is provided below the openings 78 and 79, and cutters 82 and 83 are provided above the openings 78 and 79. The cutters 82 and 83 are respectively supported by a support 80, can be moved in the up-and-down direction and the axial direction (Y) of the support 80 independently of each other. The cutter 82, 83 are rotation angle can also be changed. The cutter 81 is supported by a support (positioned below the guide 72), and can be moved in the up-and-down direction and the axial direction (Y) of the support. The cutters 81, 82 and 83 are linear, and make linear cuts in the sheet S1.

In FIG. 12, the sheet S1 is inserted between the guides 71 and 72 from the paper feed port 73, and is conveyed by the conveyance rollers 76 and 77. When the center of the sheet S1 reaches the positions of the openings 78 and 79, the conveyance is stopped. Next, the cutter 81 moves up toward the sheet surface, and makes a cut 61a as shown in FIG. 13A.

Besides, the cutter 82 moves in the axial direction (Y), and moves to one end of the cut 61a. Similarly, the cutter 83 moves in the axial direction (Y), and moves to the other end of the cut 61a. Then, the cutters 82 and 83 move down toward the sheet surface, and make cuts 61b and 61c in the sheet S1. Accordingly, for example, a trapezoidal cut 61 is formed in the sheet S1. Incidentally, an identification image 63 is printed in an area defined by the cut 61 of the sheet S1.

Since the positions of the cutters 81, 82 and 83 can be moved in the axial direction (Y), the position where the cut 61 is formed and the length of the cut 61a in the Y direction can be changed. Besides, since the cutters 82 and 83 can be rotated, the angles of the cuts 61b and 61c can also be changed.

When the cut 61 is formed in the sheet S1, the cutters 81, 82 and 83 are separated from the sheet S1, and the sheet S1 is conveyed by the conveyance rollers 76 and 77, and is discharged from the cutter unit 40.

FIG. 13B shows a state where the sheet S1 in which the cut 61 is formed is folded. When the sheet is folded, since the portion of the cut 61 is raised by the rigidity of the sheet S1, a tag 62 is formed.

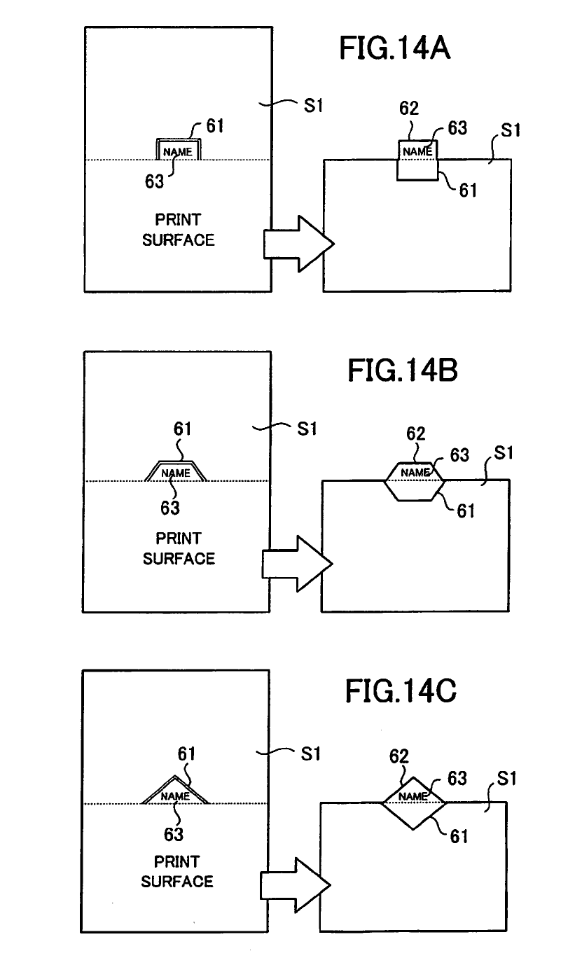

FIG. 14A to FIG. 14C show shapes of the cuts 61 formed by the cutter unit 40 of FIG. 12. FIG. 14A to FIG. 14C are views in which the sheet S1 is seen from the print surface. FIG. 14A shows an example in which the shape of the cut 61 is rectangular, FIG. 14B shows an example in which the shape of the cut 61 is trapezoidal, and FIG. 14C shows an example in which the shape of the cut 61 is triangular.

The shape of the cut 61 can be changed by adjusting the angles of the cutters 82 and 83. Accordingly, since the shape of the tag 62 is changed when the sheet S1 is folded, and possible to know by the shape of the tag 62 who printed. Besides, the position of the tag 62 may be changed. By changing the shape and the position of the tag 62 for each user, possible to more easily identify who printed.

Incidentally, the structure of the cutter unit 40 is not limited to the example of FIG. 8 or FIG. 12, and another modification can also be made.

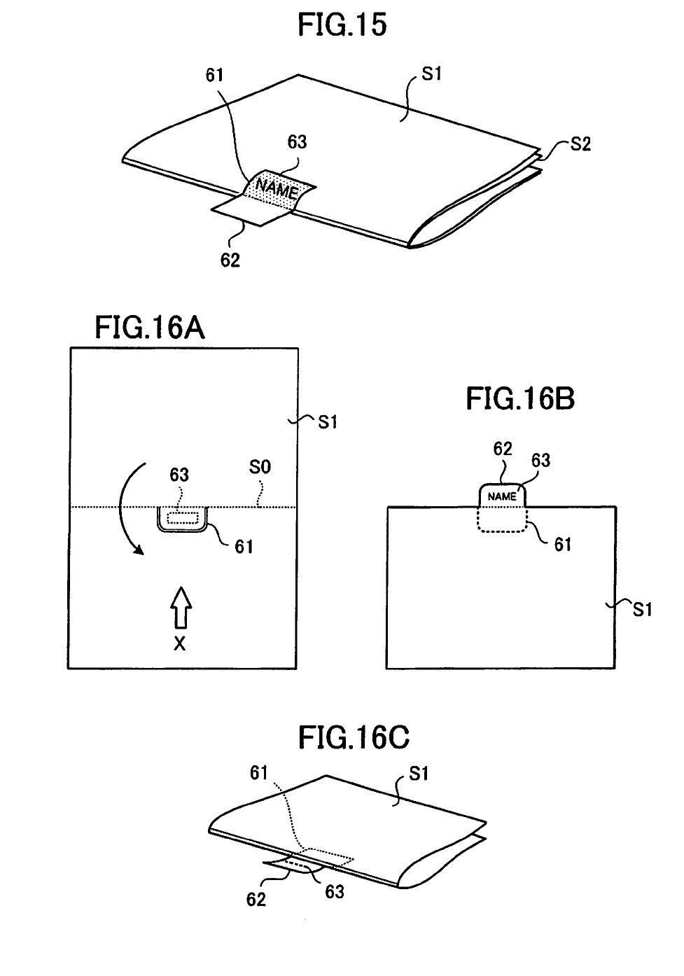

FIG. 15 is a view showing a display example of an identification image 63 when the tag 62 is formed. FIG. 15 shows an example in which when plural sheets are bundled and are folded in two, the identification image 63 is printed on the back of the sheet S2 positioned at the inside of the outermost sheet S1.

For example, assume that two sheets (S1 and S2) are placed on top of each other and are folded. When the cut 61 is made in the outside sheet S1 and the tag 62 is formed, the identification image 63 is printed on the inside sheet S2 closest to the sheet S1 and at the position opposite to the cut 61. When the tag 62 is raised, the identification image 63 printed on the inside sheet S2 can be confirmed.

FIG. 16A to FIG. 16C show examples in which the direction of the cut 61 is changed. That is, when the sheet S1 is conveyed in the X direction, the center line S0 of the sheet S1 is made the starting point, and the cut 61 is formed in a direction toward the rear end of the sheet S1. Besides, the identification image 63 is printed on the back surface of the area defined by the cut 61. When the sheet S1 is folded, the tag 62 is raised as shown in FIG. 16B, and the identification image 63 printed on the back side is seen. FIG. 16C shows the sheet S1 folded in two. Although the cut 61 is concealed on the lower side, when the tag 62 is raised, the identification image 63 can be seen from above.

Accordingly, with respect to the direction of formation of the cut 61, the cut can be formed in the front end direction (FIG. 7B) or in the rear end direction (FIG. 16A) while the center line S0 of the sheet is made the starting point. Besides, when the surface on which the identification image 63 is printed is selected according to the direction of the cut 61, the identification image 63 can be confirmed from above the sheet folded in two.

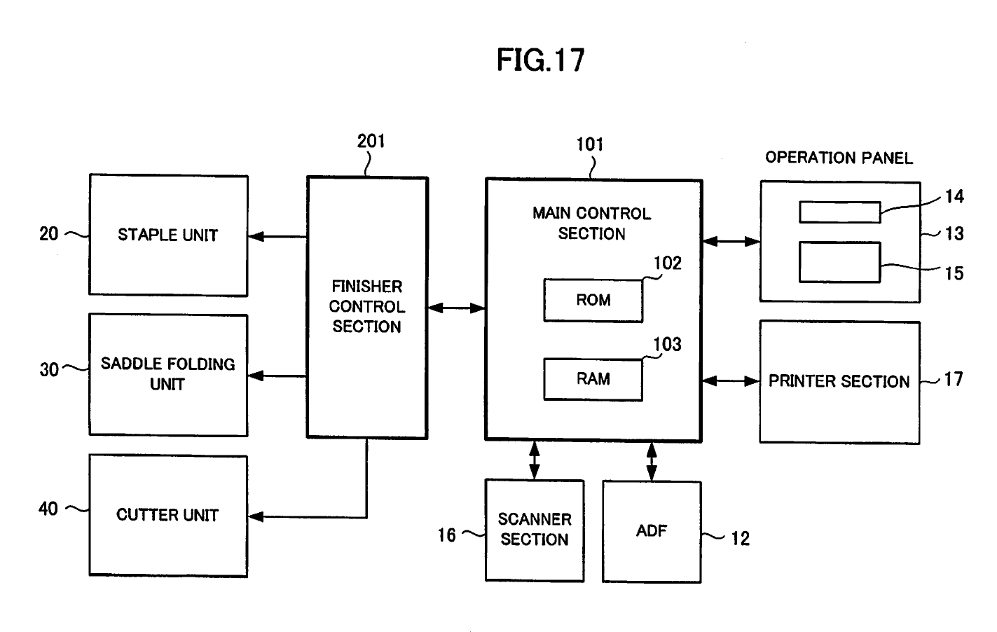

FIG. 17 is a block diagram showing a control system of the image forming apparatus 100 and the finisher 200.

In FIG. 17, a main control section 101 includes a CPU, a ROM 102 and a RAM 103, and controls the image forming apparatus 100 in accordance with a control program stored in the ROM 102. The main control section 101 controls the operation of the ADF 12, the scanner section 16 and the printer section 17 in response to the operation of the operation panel 13. The RAM 103 temporarily stores control data and is used for computing at the time of control.

The operation panel 13 includes the plural keys 14 and the display section 15 serving also as the touch panel, and can give various instructions for image formation. For example, the instruction of the number of copies is performed by using the key 14, and the instruction of the sheet size, sheet type and staple, the instruction of sheet folding, and the like are performed by operating the touch panel of the display section 15.

Besides, a finisher control section 201 controls the operation of the finisher 200. The finisher control section 201 is connected to the main control section 101, and transmits and receives information to and from the main control section 101, and the image forming apparatus 100 and the finisher 200 cooperate to operate. The finisher control section 201 controls the staple unit 20, the saddle folding unit 30 and the cutter unit 40, respectively.

As the control of the staple unit 20, the control of the position of the stapler 25, the execution of stapling, the conveyance of the sheet to the stapler 25, and the discharge of the sheet bundle after stapling are performed. As the control of the saddle folding unit 30, the control of the stapler 32, the control of the blade 38, and the rotation control of the folding roller pair 35A, 35B and the discharge roller pair 37A, 37B are performed.

As the control of the cutter unit 40, the control of whether the cut 61 is made, and the control of the moving up-and-down and the position of the cutter 41 of FIG. 8, or the control of the moving up-and-down and the position of the cutters 81, 82 and 83 of FIG. 12 are performed. The position of the cut 61 or the shape of the cut 61 is changed. Besides, carrying-out of the sheet S1 after the cut 61 is made is performed.

In the embodiments as described above, the cut is made in the center of the sheet, and the center of the sheet is bent by the saddle folding unit, so that the tag can be easily formed. Besides, the user name or the like is printed on the tag, or the position or the shape of the tag is changed, so that the printing user can be easily identified.

Incidentally, the invention is not limited to the foregoing embodiments, but various modifications can be made within the scope not departing from the scope of claims.

Although exemplary embodiments are shown and described, it will be apparent to those having ordinary skill in the art that a number of changes, modifications, or alterations as described herein may be made, none of which depart from the spirit. All such changes, modifications, and alterations should therefore be seen as within the scope.

What is claimed is:

1. A sheet finishing apparatus comprising:
a cutter unit which is disposed on a conveyance path of a sheet, and forms a cut for tag formation in the sheet from a starting point close to a center line of the sheet orthogonal to a conveyance direction;
a folding unit which is disposed downstream of the cutter unit on the conveyance path, bends the sheet around the center line, and raises an area defined by the cut by the bending to form the tag; and
a storage tray to which the sheet bent by the folding unit is discharged.

2. The apparatus of claim 1, wherein a printer section previously prints identification information on the area defined by the cut in the sheet, and the identification information printed on the tag can be confirmed from above.

3. The apparatus of claim 1, wherein
the folding unit can bend a sheet bundle in a direction orthogonal to the conveyance direction,
the cutter unit forms the cut in an outermost first sheet of the bent sheet bundle, and
an identification information is printed on an inside sheet in the sheet bundle closest to the first sheet and at a position opposite to the cut portion.

4. The apparatus of claim 1, wherein the cutter unit can form the out at a plurality of different positions.

5. The apparatus of claim 1, wherein the cutter unit can form the cut in a plurality of different shapes.

6. The apparatus of claim 1, wherein the cutter unit can form the cut at a plurality of different positions and in different shapes.

7. The apparatus of claim 1, wherein the cutter unit includes a U-shaped cutter which can move along the center line of the sheet, and can move up and down to a sheet surface direction of the sheet.

8. The apparatus of claim 1, wherein the cutter unit includes a plurality of linear cutters which can move along the center line of the sheet, and can move up down to a sheet surface direction of the sheet.

9. The apparatus of claim 1, wherein the folding unit includes a stapler to staple the center line of the sheet, and the cutter unit forms the cut at a position avoiding the staple.

10. A sheet finishing method, comprising:
disposing a cutter unit on a conveyance path of a sheet, forming a cut for tag formation in the sheet from a starting point close to a center line of the sheet orthogonal to a conveyance direction;
disposing a folding unit downstream of the cutter unit on the conveyance path, bending the sheet around the center line,
raising an area defined by the cut by the bending to form the tag; and
discharging the sheet bent by the folding unit to a storage tray.

11. The method of claim 10, wherein a printer section previously prints identification information on the area defined by the cut in the sheet, and the identification information printed on the tag can be confirmed from above.

12. The method of claim 10, wherein
the folding unit bends a sheet bundle in a direction orthogonal to the conveyance direction,
the cutter unit forms the cut in an outermost first sheet of the bent sheet bundle, and
an identification information is printed on an inside sheet in the sheet bundle closest to the first sheet and at a position opposite to the cut portion.

13. The method of claim 10, wherein the cutter unit forms the cut at a plurality of different positions.

14. The method of claim 10, wherein the cutter unit forms the cut in a plurality of different shapes.

15. The method of claim 10, wherein the cutter unit forms the cut at a plurality of different positions and in different shapes.

16. The method of claim 10, wherein the folding unit includes a stapler to staple the center line of the sheet, and the cutter unit forms the cut at a position avoiding the staple.

17. An image forming apparatus comprising:
a printer section to form an image on a sheet;
a cutter unit which is disposed on a conveyance path of the sheet on which an image is formed by the printer section, and forms a cut for tag formation in the sheet from a starting point close to a center line of the sheet orthogonal to a conveyance direction;
a folding unit which is disposed downstream of the cutter unit on the conveyance path, bends the sheet around the center line, and raises an area defined by the cut by the bending to form the tag; and
a storage tray to which the sheet bent by the folding unit is discharged.

18. The apparatus of claim 17, wherein the printer section previously prints identification information on the area defined by the cut in the sheet, and the identification information printed on the tag can be confirmed from above.

19. The apparatus of claim 17, wherein
the folding unit can bend a sheet bundle in a direction orthogonal to the conveyance direction,
the cutter unit forms the cut in an outermost first sheet of the bent sheet bundle, and
the identification information is printed on an inside sheet in the sheet bundle closest to the first sheet and at a position opposite to the cut portion.

20. The apparatus of claim 17, wherein the cutter unit changes a formation position of the cut or a shape of the cut according to a user.
